(19) United States
(12) Patent Application Publication
(10) Pub. No.: US 2016/0028665 A1
(43) Pub. Date: Jan. 28, 2016

(54) NETWORK AND DEVICE SOLUTION ON SPONSORED DATA APPLICATION

(71) Applicant: Verizon Patent and Licensing Inc., Arlington, VA (US)

(72) Inventors: Lixia Yan, Basking Ridge, NJ (US); Mauricio Pati Caldeira de Andrada, South Plainfield, NJ (US); Zhengfang Chen, Millburn, NJ (US)

(21) Appl. No.: 14/337,441

(22) Filed: Jul. 22, 2014

(51) Int. Cl. H04L 12/58; H04W 12/08; H04W 72/04; H04L 29/08; H04W 4/00

(52) U.S. Cl. CPC H04L 51/046; H04L 67/141; H04W 4/003; H04W 72/044; H04W 12/08

(57) ABSTRACT

Subscription status notification techniques are provided. A request is received by at least one server from a user equipment (UE) to attach to a wireless packet data communication network. The server determines whether the UE is associated with an enterprise identified by a service provider of the network as a sponsor of a data service through the network, based on an account of the UE stored on the server. Upon determining that the UE is associated with the enterprise, a notification message is sent from the server to the UE, through an information element field within an existing message in a bearer channel of the network. The UE is configured to control access to the network responsive to the subscription status in the notification message. The UE permits access to a sponsored data service associated with the enterprise sponsor regardless of the UE's ability to access non-enterprise associated data services.

### BACKGROUND

In recent years, mobile wireless communications have become increasingly popular. The explosion of technology has also continued. New ideas have emerged to mix together various software and hardware solutions to provide the user with intuitive experiences that simplify the use of these new technologies. Currently, with the influx of various smart devices as well as the emergence of software solutions for browsers, true platform independent communications may be possible.

Today, many major enterprises (e.g., retail stores, online stores, financial institutions, etc.) have mobile applications available to be downloaded and installed on mobile devices. These applications provide a fast and easy way for mobile device users to make online purchases from their mobile devices, anytime and anywhere.

The intention of these enterprises is to prompt their sales as well as to provide convenience to consumers via the mobile applications. To use mobile applications, however, it is assumed that the mobile device has an Internet connection. If the customer is not able to access a Wi-Fi network, the user must use cellular data minutes or bytes, for example, when launching the application, browsing products, and making any transactions with the application. Cellular data usage for communication over the Internet, however, is not free. Thus, some customers, for example, customers who purchase a limited monthly data usage (such as a low allowance of 75 MB or less per month), customers who have exhausted a monthly data allowance, or customers who have not purchased data service and do not have a Wi-Fi connection, may be reluctant or unable to take advantage of mobile applications for online shopping or other transactions.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a high-level functional diagram of an example of a wireless packet data communication network for providing mobile communications for user equipment associated with a sponsored data service as well as a system providing a framework for providing subscription status information to user equipment associated with the sponsored data service.

FIG. 2 illustrates example information content for specific fields of a protocol configuration option (PCO).

FIG. 3 is a table illustrating examples of PCO values for user equipment with various subscription service plans and data usage states.

FIG. 4 is a signal flow diagram illustrating an example of subscription status messaging during account activation/attachment to a network for user equipment associated with a sponsored data service.

FIG. 5 is a signal flow diagram illustrating an example of subscription status messaging during a communication session when the subscription status of user equipment changes responsive to data usage exceeding a predetermined limit.

FIG. 6 is a flow chart diagram illustrating an example of network access control by user equipment responsive to subscription status notification messaging.

FIG. 7 is a high-level functional block diagram of an example user equipment, as may be involved in some sponsored data applications.

FIG. 8 is a simplified functional block diagram of a computer that may be configured as a host or server in the system of FIG. 1.

FIG. 9 is a simplified functional block diagram of a personal computer or other work station or terminal device.

### DETAILED DESCRIPTION OF EXAMPLES

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

As above, a need exists to provide consumers the convenience of using commercial mobile applications without the user having to consume their data allotment under their mobile network service plan or even when they may not have a data service plan. Accordingly, it is desirable that a wireless carrier and/or commercial enterprise cover the cost of data usage consumed by users when using the commercial applications, such that usage of these applications is free-of-charge to the users, and the data usage is sponsored either by the wireless carrier or the commercial enterprise(s).

There are challenges both for the network and for the mobile device, with respect to providing free-of-charge mobile network service for sponsored enterprise mobile applications. For the network, it may be difficult to differentiate sponsored data usage and non-sponsored data usage. This differentiation is important, so that sponsored data usage is not billed to the customer. For network service subscribers with no data service or for subscribers who have reached a data usage limit, it may be difficult to allow data requests from a sponsored data application to go through the network while blocking other data requests that would incur usage costs to the mobile device subscriber. For the mobile device, it may be difficult for the device to instruct the user that certain applications are free of a data charge. It may also be difficult for the mobile device to allow a sponsored data application to run on the device while blocking all other data requests, when the customer does not have a data service subscription or has exhausted a data usage limit under their network subscription plan.

The examples described herein provide a streamlined combined network-device solution to address the above problems. The various examples described herein relate to subscription status notification messaging methods and systems. A request to attach to a wireless packet data communication network is received by at least one server from a user equipment (UE). The server(s) determines whether the UE is associated with an enterprise identified by a service provider of the network as a sponsor of a data service through the network, based on an account of the UE stored on the server(s). Upon determining that the UE is associated with the enterprise, a notification message is sent from the server(s) to the UE, through an information element field within an existing message in a bearer channel of the network. The UE is configured to control access to the network responsive to the subscription status in the notification message. The UE permits access to the data service sponsored by the enterprise regardless of an ability of the UE to access data services not associated with the enterprise. As described further below, the UE may or may not be capable of accessing other data services not associated with the enterprise (such as the Internet). For example, the UE may not have an account for other data services not associated with the enterprise, may have an account that permits access to another data service or may be currently restricted from access to the other data service due to data usage limit exhaustion. The enterprise that sponsors the data service may be the carrier or another entity having a subscription agreement with the carrier to pay the carrier for device usage of the sponsored data service. A UE is associated with the enterprise in that the UE is one of a number of devices that the enterprise has identified as being authorized to access and use the data service sponsored by the enterprise, for example, because the UE has downloaded an application of the enterprise to enable a user of the UE device to conduct business of an appropriate kind with the enterprise using the sponsored data service.

In some examples, the UE is not associated with a service provider account of another data service. The other data service is not associated with the sponsored data service. In these examples, the subscription status also indicates that the UE is not associated with the service provider account, and the UE restricts access to the other data service (such as an Internet data service). For example, the UE can restrict access by preventing access to the other data service or by redirecting the user to purchase, change and/or replenish the service provider data service plan, e.g. with the carrier, having the other data service.

In some examples, the UE is not associated with an account of another data service. The other data service may be associated with the sponsored data service, but may be a different (overlapping or non-overlapping) free-of-charge service (provided by the enterprise) for a different UE. In these examples, the subscription status indicates that the UE is not associated with the other data service of the enterprise, and the UE restricts access to the other data service. For example, the sponsored data service and the other data service may be associated with different portals of a sponsored service network. Based on the subscription status of the UE, the UE can be directed to the portals of the network associated with the sponsored data service or the other data service.

With respect to the network, a new service profile is generated for the subscriber account that is associated with a sponsored data service. The profile is associated with data access restriction rules. The rules indicate that the account does not have normal (unrestricted) Internet access. Rather, only the uniform resource locators (URLs) of the sponsored data application are allowed access. A subscription status code is sent to the UE (via a PCO message) when the UE registers with the network. The subscription status code is used to indicate to the UE that the account is a sponsored data service account, allowing only sponsored data application data requests to go through the network, and not having normal (unrestricted) data access. The sponsored data is allowed to be transmitted over a sponsored service packet data network (PDN), so that the subscriber is not billed.

With respect to the UE, the device registers the sponsored data application to use the sponsored service PDN. Thus, all data requests with the sponsored application are transmitted over the sponsored service PDN, regardless of whether the application is running in the foreground or background on the UE. The UE checks the subscription status code (via the PCO message) at power up. If the PCO value indicates that the UE supports the sponsored data account only, the UE delivers an instructional message, via a user interface, to inform the user. For example, the user interface may indicate that the current account type only allows the user to use a certain application (which uses sponsored data) for free but does not permit access to regular Internet service. In some examples, the user interface may provide an opportunity for the user to purchase data for regular (unrestricted) Internet access.

The use of sponsored data applications is a service that may benefit multiple parties. For example, sponsored data retail/online stores are motivated to provide sponsored data applications to the consumers, to promote more online purchases from mobile devices (leading to an increase in revenue). Wireless operators may benefit, by selling more mobile devices that supports such applications. Sponsored data applications provide consumers with a free, fast and easy way to make purchases from their mobile devices without consuming their data usage allowance. Because the UE restricts (or blocks) regular Internet access for subscribers who only have access to the sponsored data service (but no service provider data service account), the subscription status notification messaging service may protect the wireless carrier's network from being impacted by UE accounts without regular internet data services.

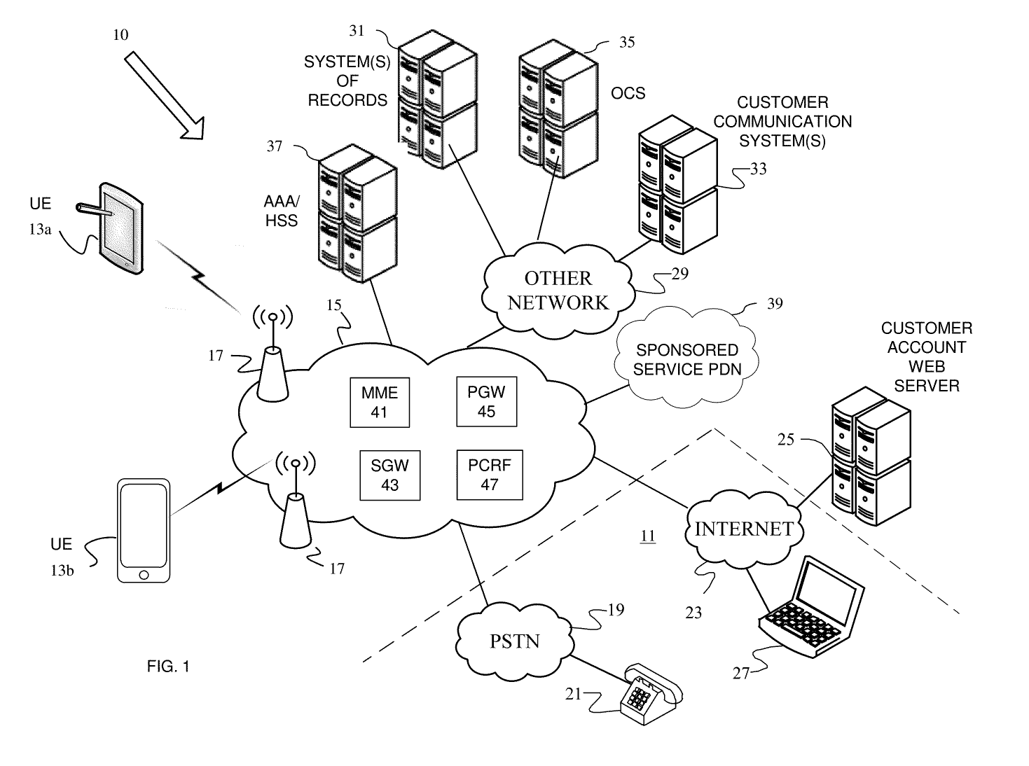

Reference now is made in detail to the examples illustrated in the accompanying drawings and discussed below. FIG. 1 illustrates a system 10 offering a variety of mobile communication services, including a subscription status messaging service for sponsored data accounts of one or more enterprises. The subscription status message service may include various functions as may be involved in monitoring a subscription status of user equipment (UE) associated with sponsored data services (sponsored by one or more enterprises), controlling access to sponsored data services and other data services (such as an Internet data service), monitoring data usage status of UE with respect to plan limits and providing status and data usage notification messages to the UEs.

For the purposes of later discussion, two UEs 13a and 13b are shown in the drawing, to represent examples of the UEs that may receive various services via mobile communication network 15. The UEs 13a, 13b are examples of UEs that may be used for the subscription status messaging service. However, the network 15 will provide similar communications for many other similar users as well as for UEs/users that do not participate in the subscription status messaging service. The network 15 provides mobile wireless communications services to those devices as well as to other UEs (not shown), for example, via a number of base stations (BSs) 17. The present techniques may be implemented in any of a variety of available mobile networks 15 and/or on any type of UE compatible with such a network 15, and the drawing shows only a very simplified example of a few relevant elements of the network 15 for purposes of discussion herein. The mobile communication network 10 provides communications between UEs as well as communications for the UEs within networks and devices 11 outside the mobile communication network 10.

The wireless mobile communication network 15 might be implemented as a network conforming to 3^{rd} Generation Partnership Project (3GPP) Long Term Evolution (LTE) standard, the code division multiple access (CDMA) IS-95 standard, the 3rd Generation Partnership Project 2 (3GPP2) wireless internet protocol (IP) network standard or the Evolution Data Optimized (EVDO) standard, the Global System for Mobile (GSM) communication standard, a time division multiple access (TDMA) standard or other standards used for public mobile wireless communications. The UEs 13a, 13b are capable of voice telephone communications through the network 15, and for the subscription status messaging service. The UEs 13a, 13b are capable of data communications through the particular type of network 15 (and the users thereof typically will have subscribed to a data service through the network).

In some examples, the network 15 allows users of the UEs to initiate and receive telephone calls to each other as well as through the public switched telephone network (PSTN) 19 and telephone stations 21 connected to the PSTN 19. In some examples, the network 15 allows short message service (SMS) type text messaging between UEs and similar messaging with other devices via the Internet 23. The network 15 typically offers a variety of other data services via the Internet 23, such as downloads, web browsing, e-mail, etc. By way of example, the drawing shows a laptop PC type user terminal 27 connected to the Internet 23; and the data services for the UEs 13a, 13b via the Internet 23 may be with devices like those shown at 27 as well as with a variety of other types of devices or systems capable of data communications through various interconnected networks. The UEs 13a, 13b of users of the subscription status messaging service also can receive and execute applications written in various programming languages, as discussed more later.

For purposes of later discussion, two UEs 13a, 13b appear in the drawing, to represent examples of the UEs that may receive various services via the mobile communication network 10. In general, UEs 13a, 13b can take the form of portable handsets, smart-phones, tablet computers, laptop personal computers (PCs), personal digital assistants (PDAs) or any portable computing device (including a wireless modem card), although they may be implemented in other form factors, including consumer and business electronic devices. UEs 13a, 13b may include a display and user input capabilities to support certain text and image communications (such as email, picture communication and web browsing applications). Program applications, including an application to assist in the subscription status messaging service can be configured to execute on many different types of UEs 13a, 13b. For example, a mobile device application can be written to execute on a binary runtime environment for a mobile (BREW-based) mobile device, a Windows Mobile based mobile device, Android, iOS iPhone or iPad, Java Mobile, or RIM based mobile device such as a BlackBerry or the like. Some of these types of devices can employ a multi-tasking operating system.

In general, UE 13a represents a portable computing device associated with a sponsor enterprise (e.g., with any company, firm, organization, government entity, etc.) that provides a sponsored data service. The sponsored data service is provided free-of-charge to the user of UE 13a. Unless the sponsoring enterprise is also the carrier that operates the network, the free-of-charge service is provided by the sponsor enterprise based on remuneration to the carrier/network service provider for the data usage service from the network. Thus, the user of UE 13a does not need Wi-Fi network access, does not consume cellular data bytes to access the sponsored data service (via the Internet), and does not have to use a data service plan (or may not necessarily have a data service plan) with a carrier/service provider of the network 10. UE 13a is configured to be compatible only with a sponsored packet data service, and is restricted from access to other (e.g., purchasable) data services, such as the Internet 23. Thus, UE 13a is allowed free-of-charge access to sponsored data services provided by the sponsored service PDN 39, while being restricted from access to Internet 23. UE 13a may include a subscriber identifier module (SIM) card holding identification information (such as an international mobile subscriber identity (IMSI) and authentication codes) to identify UE 13a as being associated with the sponsored data service.

In some examples, the UE (e.g., UE 13a) is also capable of purchasing a service provider data service plan. UE 13b represents a portable computing device associated with a sponsor enterprise that also includes a service provider (i.e., purchased) data service. The user of UE 13b is permitted free-of-charge access to sponsored service PDN 39, and also access to Internet 23 (according to a data usage plan of the service provider data service).

Hence, FIG. 1 illustrates a mobile communication network 10 as may be operated by a carrier or service provider to provide a wide range of mobile communication services and ancillary services or features to its subscriber customers, sponsor enterprise customers and associated UE users. The elements generally indicated by the reference numeral 10 generally are elements of the network and are operated by or on behalf of the service provider or carrier, although the UEs 13a and 13b may be sold to the sponsor enterprise's customers. The network 10 may include other UEs (not shown) that are not associated with sponsored service PDN 39, which may be permitted access to Internet 23 (and restricted from access to sponsored service PDN 39).

The mobile communication network 10 typically is implemented by a number of interconnected networks. Hence, the overall network 10 may include a number of radio access networks (RANs), as well as regional ground networks interconnecting a number of Radio Access Networks (RANs) and a wide area network (WAN) interconnecting the regional ground networks to core network elements, such as Multimedia Messaging Service Centers (MMSCs) (not shown). A regional portion of the network 10, such as that serving UEs 13a and 13b will typically include one or more RANs and a regional circuit and/or packet switched network and associated signaling network facilities.

Physical elements of a RAN, operated by one of the mobile service providers or carriers, include a number of base stations represented in the example by the base stations (BSs) 17. Such base stations 17 typically comprise a base transceiver system (BTS) which communicates via an antennae system at the site of base station and over the airlink with one or more of the UEs 13a, 13b when the UEs are within range. Each base station 17 typically includes a BTS coupled to several antennae mounted on a radio tower within a coverage area often referred to as a “cell.” The BTS is the part of the radio network that sends and receives radio frequency (RF) signals to/from the UEs 13a, 13b that are served by the base station 17. Later generations mobile networks (such as LTE networks) utilize wireless access elements, each referred to as an evolved node B (eNodeB or eNB), to provide functions similar to those of a base station; but for convenience, the discussion here will generally include eNodeBs and other network wireless access devices under the general term base station.

The radio access networks also include a traffic network represented generally by the cloud at 15, which carries the user communications for the UEs 13a, 13b between the respective base stations 17 and other elements with or through which the UEs 13a, 13b communicate. The network can also include other elements that support functionality other than device-to-device media transfer services such as SMS messages (as well as other messaging service messages such as Multimedia Messaging Service (MMS) messages, Rich Communication Suite (RCS) messages) and voice communications. Specific elements of the network 15 for carrying the voice and data traffic and for controlling various aspects of the calls or sessions through the network 15 are omitted here for simplicity. It will be understood that the various network elements can communicate with each other and other aspects of the mobile communications network 10 and other networks (e.g., PSTN 19, Internet 23 and sponsored service PDN 39) either directly or indirectly. Individual elements such as switches and/or routers forming the traffic network 15 are omitted here for simplicity.

The traffic network portion 15 of the mobile communication network 10 connects to a public packet switched data communication network, such as the network commonly referred to as the “Internet” shown at 23. Packet switched communications via the traffic network 15 and the Internet 23 may support a variety of user services through the network 10, such as mobile device communications of text and multimedia messages, e-mail, web surfing or browsing, programming and media downloading (including audio and video), etc. For example, UE 13b (having a service provider data service plan for Internet access) may be able to receive messages from and send messages to user terminal devices, such as personal computers, either directly (peer-to-peer) or via various servers (not separately shown). The drawing shows one such user terminal device as a PC 27, by way of example. For purposes of discussing (subscription status and data usage) notification messages, some notifications may entail an e-mail message transmission of the notification to the account holder's terminal, such as to the PC 27 via the Internet 23.

The traffic network portion 15 of the mobile communication network 10 also connects to the sponsored service PDN 39. Packet switched communications via the traffic network 15 and the sponsored service PDN 39 may support a variety of sponsored enterprise data services through the network 10, such as launching sponsored data service applications, browsing products, and making any transactions. Other sponsored data services may include communication of messages (e.g., text, multimedia and/or email) with the sponsored enterprise.

The carrier also operates a number of systems that provide ancillary functions in support of the communications services and/or application services provided through the network 10, and those elements communicate with other nodes/elements of the network 10 via one or more private IP type packet data networks 29 (sometimes referred to as an Intranet), i.e., a private network. Generally such systems are part of or connected for communication via the private network 29. It should be apparent, however, to recognize that systems outside of the private network could serve the same functions as well. Examples of such systems, in this case operated by the network service provider as part of the overall network 10, which communicate through the intranet type network 29, include one or more system(s) of records 31, customer communication system(s) 33 and online charging system (OCS) 35.

One or more systems of records 31 may include subscriber account records. A large carrier typically has a number of such systems, and the system that stores the account data for a particular subscriber may be referred to as the “system of record” for that subscriber's account.

OCS 35 provides real time credit control and charging for communication services. For example, it provides an account balance management function, credit control information, and allows a communications service provider to charge their customers, in real time, based on service usage. OCS 35 instructs PDN Gateway (PGW) 45 how much data the user is allowed to use (e.g., a data quota).

OCS 35 accesses the account data (such as from system(s) of records 31 or from Home Subscriber Server (HSS) 37) for UEs (such as UE 13b) that subscribe to a service provider data service and determines a data usage. For example, a calculation is performed, based on the real-time data usage, a predetermined usage data limit, the present time, and the account cycle, to determine a current usage amount and a time remaining in the cycle. The current data usage is compared with a predetermined usage data limit to determine whether the usage data limit has been exceeded. If the predetermined data usage limit is exceeded, OCS 35 generates a data usage notification message for transmission via the private network 29. For example, upon determining that the current data usage limit is exceeded, a notification message is provided to the mobile device 13b with a suggestion to either replenish the account or to change to a different subscription plan. In the examples, data usage is measured by duration, e.g., length of time of a voice call, length of time of a data communication session, volume of the consumed data, and/or simply packets of data communicated with a guaranteed quality of service (QoS) supporting real-time communications of an appropriate bandwidth.

In some examples, network 10 also includes a customer communications system 33, which is coupled for communication via the private network 29. The customer communications system 33 receives the data usage notification request message from OCS 35; and in response, generates and sends one or more notification messages. For example, the customer communications system 33 may generate and send the notification message in a PCO in the bearer channel (described further below) to UE 13b designated as that of the account holder. For example, customer communication system 33 may apply additional logic or ‘business rules’ to the notification messages regarding various types of usage and what is preferred by various subscribers. In some examples, the OCS 35 itself sends data usage notification messages to UE 13b.

In one example, the carrier also offers its subscribers on-line access to a variety of functions related to the subscribers' accounts, such as review of billing statements and usage data, on-line payment, subscription changes, password control or the like. For that purpose, the carrier in the example shown in FIG. 1 operates a customer account web server 25, providing an account subscriber interface via the Internet 23. Hence, a user's terminal, such as PC 27, may be used to access on-line information about a subscriber's service plan account, which the mobile carrier makes available via the carrier's web site accessible through the Internet 23 (or network 15).

Of note for purposes of this discussion, many of the subscription status/data usage notification messages discussed herein are sent to various UEs using the PDN 15 (also referred to as an IP Multimedia Subsystem (IMS) PDN 15). An Evolved Packet Core (EPC) of network 15 uses the concept of Evolved Packet System (EPS) bearer channels to route IP traffic from PGW 45 in the network 15 to the UE (e.g. 13a and 13b). A bearer channel is an IP packet flow with a defined quality of service (QoS) between the PGW 45 and the UE (e.g., 13a and 13b). It is within these packets that subscription status/data usage notification messages are sent to the UEs 13a, 13b.

For example, network 10 provides a subscription status notification message to the UEs (e.g., 13a, 13b) when the UE requests activation of the sponsored (enterprise) data service account. Network 10 also provides a subscription status notification message to the UE (such as UE 13a) when the subscription status of the UE has changed (e.g., when a user of the UE 13a, which previously supported the sponsored data service only, purchases a service provider service plan). Network 10 also provides a data usage notification to the UE (e.g., UE 13b), when the current data usage of UE 13b (for the service provider data service account) exceeds a predetermined data usage limit.

Network 10 provides a subscription status/data usage notification message in an information element field within an existing message from network 15 to the UE (e.g., 13a, 13b). In one example, the notification message is embedded in the PCO in the message to the UE through the bearer control plane. In some examples, the notification message (e.g., subscription status notification message and/or the data usage notification message) includes options to purchase a service provider account and/or to replenish/change the service provider account. In some examples, the notification message includes instructions to permit access to sponsored service PDN 39; and permit or restrict access to Internet 23. The PCO is an information element field within the existing message from the network 15 to the UE (e.g., 13a, 13b). Thus, the PCO may be used to provide subscription status information, data usage information and/or instructions to the UE (e.g., 13a, 13b) in connection with permitted network access and (service provider) data usage.

In some cases, network 10 may also send a data usage notification message to a UE of one or more other users on the same user account. Thus, when UE 13b exceeds a predetermined data usage limit, network 10 may also provide a notification message in the form of a PCO message sent via PGW 45, traffic network 15, one of base stations 17 and a signaling channel over the air link to another UE (not shown) associated with the same user account.

The EPC is a main component of a System Architecture Evolution (SAE) core network architecture of 3GPP's LTE wireless communication standard. The SAE has a flat, all-IP architecture with separation of control plane and user plane traffic. The EPC includes Mobility Management Entity (MME) 41, serving gateway (SGW) 43, PGW 45, Policy Control and Charging Rules Function (PCRF) 47 and HSS 37.

MME 41 is a control-node for the communication access network. For example, it is used for idle mode UE tracking and paging procedure including retransmissions. It also provides bearer channel activation/deactivation process and selection of the SGW 43 for the UEs 13a, 13b. MME 41 also provides authentication of the user by interacting with HSS 37. MME 41 also terminates an Sha interface towards HSS 37 for roaming UEs.

HSS 37 is a central database that contains user-related and subscription-related information in a subscription profile repository (SPR). For example, the SPR stores Mobile Station International Subscriber Directory Number (MSISDN), SIM-card identification information, and the like. The user-related/subscription related information includes service provider data service account information and/or sponsored enterprise subscription information associated with particular UEs (e.g., based on device identification information such as the IMSI). The sponsored enterprise subscription information may include an indication that the UE has access only to sponsored service PDN 39 (such as UE 13a) and/or has a service provider data account (such as UE 13b). The sponsored enterprise subscription information may also include an indication that the sponsored data service is free-of charge, so as not to bill the user for the sponsored data service.

HSS 37 also provides features such as mobility management and call and session establishment support. In addition, HSS 37 provides user authentication and access authorization (AAA) features. The AAA function provides authentication of the SIM used for the UE and determines what network services the SIM is authorized to use, e.g., sponsored enterprise (free-of-charge) data services and/or paid service provider data services. Further, it accumulates accounting records that may be used for billing purposes. Although FIG. 1 illustrates the functions of the AAA, HSS and SPR as being performed by one server, in some examples, these functions may be performed by more than one physically separated server.

PGW 45 provides connectivity from UEs 13a, 13b to external packet data networks including sponsored service PDN 39 and/or Internet 23. PGW 45 is a point of exit and entry of traffic for the UEs 13a, 13b. PGW 45 monitors how much data is used by a UE (e.g., 13a and 13b) at any given time.

PCRF 47 provides for policy control decision-making, as well as for controlling the flow-based charging functionalities in the Policy Control Enforcement Function (PCEF), which resides in PGW 45. PCRF 47 provides QoS authorization that decides how certain data flow is treated in the PCEF and ensures that this is in accordance with the user's subscription profile.

SGW 43 routes and forwards data packets to UEs 13a and 13b through MME 41. For example, a data packet can include a subscription status and/or data usage notification message. SGW 43 manages and stores mobile device parameters of the IP bearer channel service, including network internal routing information.

As discussed above, network 15 provides subscription status/data usage notification messages to UEs 13a, 13b in the form of a PCO in the bearer channel. The PCO, in one embodiment, is a type 4 information element with a minimum length of 3 octets and a maximum length of 253 octets. For example, the PCO may include the following information to UEs 13a, 13b:
0001H (P-CSCF IPv6 Address);
0002H (IM CN Subsystem Signaling Flag);
0003H (DNS Server IPv6 Address);
0004H (Policy Control rejection code);
0005H (Selected Bearer Control Mode);
0006H (Reserved);
0007H (DSMIPv6 Home Agent Address);
0008H (DSMIPv6 Home Network Prefix);
0009H (DSMIPv6 IPv4 Home Agent Address);
000AH (Reserved);
000BH (Reserved);
000CH (P-CSCF IPv4 Address);
000DH (DNS Server IPv4 Address);
000EH (MSISDN);
000FH (IFOM-Support);
0010H (IPv4 Link MTU); and
FF00H to FFFFH reserved for operator specific use.

In some examples, when the subscription status is requested/changed or the data usage exceeds a predetermined limit, the container identifier inside the PCO is set to one of the reserved fields FF00H to FFFFH, to provide subscription status and/or data usage information to the UEs 13a, 13b in the notification message. Further, the container identifier fields FF00H to FFFFH can be used to provide instructions to the UE 13a, 13b to control network access by a UE (e.g., 13a, 13b).

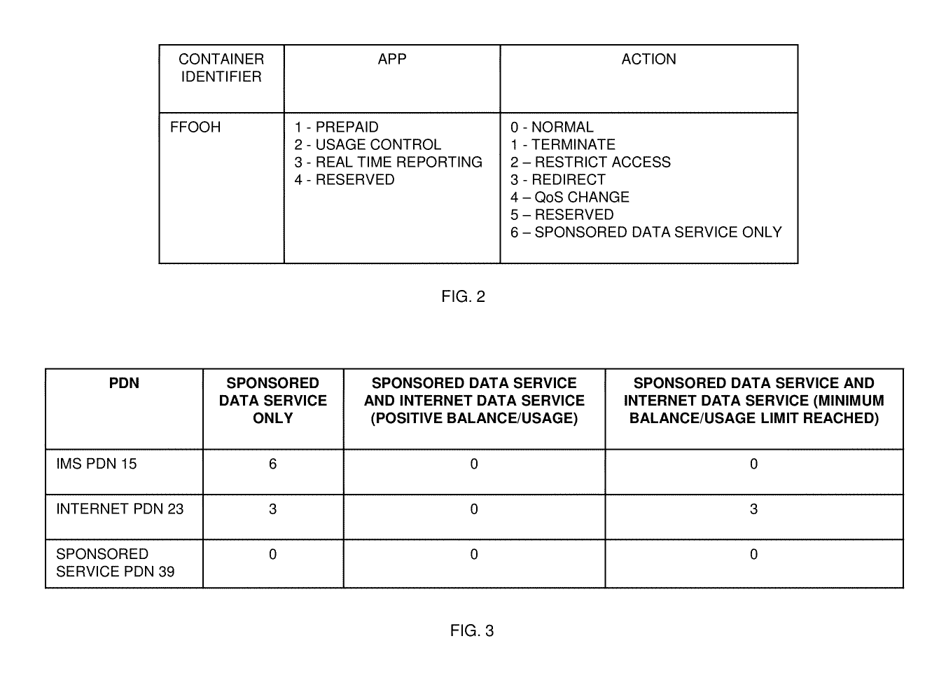

FIG. 2 illustrates an example information container content for field FF00H that may be tailored for each UE (e.g., 13a and 13b). The container content format includes an application (APP) section and an action section. The action section may be used to control network access by each UE (ACTION=1-3) and also indicate that the UE is associated with a sponsored data service only (ACTION=6).

For example, by specifying ACTION=0, the UE (such as UE 13b) is permitted normal (unrestricted) access to the network (such as unrestricted access to Internet 23 and to sponsored service PDN 39). By specifying ACTION=2, the UE may be denied network access except for IP addresses which allow a change or replenishment of the service provider subscription plan, once a data usage criterion is met. In another example, an ACTION=3, redirects the UE user to a site in connection with a specific provider, while denying any other network access. In some examples, the user of the UE can generally access change/replenishment web-sites even when an account criterion is reached (e.g., in either ACTION=2 or 3).

By specifying ACTION=6, the UE (such as UE 13a) may be permitted access to sponsored service PDN 39 only and restricted from other network access (such as to Internet 23). In some examples, the UE may be denied Internet 23 access except for IP addresses which allow the addition of a service provider subscription plan.

FIG. 3 is a table illustrating example PCO values (in a PCO message) for a UE (e.g., 13a, 13b) with various subscription service plans and data usage states. Specifically, the table shows action values (indicated in the container content of a PCO, as shown in FIG. 2) with respect to IMS PDN 15, Internet PDN 23 and sponsored service PDN 39. The action values are set by network 10, based on the subscription information and/or any data usage information of the respective UE 13a, 13b. The PCO values in the notification (PCO) message are received by the UE (e.g., 13a or 13b), and instructs the UE on the permitted access of the device to various PDNs within network 10 (e.g., IMS PDN 15, Internet PDN 23 and sponsored service PDN 39). Thus, the UE (e.g., 13a, 13b) can control its access to network 10, based on the received PCO message.

The first column illustrates example subscription status PCO values for UE 13a, which has a sponsored data service plan only (i.e., restricted access to Internet PDN 23). For a sponsored data service plan only, ACTION=6 is specified for IMS PDN 15; ACTION=3 is specified for Internet PDN 23; and ACTION=0 is specified for sponsored service PDN 39. Thus, UE 13a permits normal (unrestricted) access to sponsored service PDN 39 and permits access to IMS PDN 15 only for the sponsored data service. UE 13a restricts access to Internet PDN 23, except for IP addresses which allow the addition of a service provider subscription plan. For example, if access to Internet 23 is attempted, the user is redirected to a site in connection with the service provider, while denying any other network access.

The second column illustrates example subscription status PCO values for UE 13b, having a sponsored data service plan and an Internet data service plan (with a positive balance and/or within a data usage limit). For a sponsored data service plan and Internet data service plan (i.e., a service provider data service plan), ACTION=0 is specified for each of IMS PDN 15, Internet PDN 23 and sponsored service PDN 39. Thus, UE 13b permits normal (unrestricted) access to all PDNs in network 10.

The third column illustrates example subscription status PCO values for UE 13b, having a sponsored data service plan and an Internet data service plan (when a minimum balance and/or a data usage limit has been reached). In this example, ACTION=0 is specified for IMS PDN 15; ACTION=3 is specified for Internet PDN 23; and ACTION=0 is specified for sponsored service PDN 39. Thus, UE 13b permits normal (unrestricted) access to IMS PDN 15 and to sponsored service PDN 39. UE 13b restricts access to Internet PDN 23, except for IP addresses which allow a change/replenishment to the service provider subscription plan. For example, if access to Internet 23 is attempted, the user is redirected to a site in connection with the service provider, while denying any other network access.

Referring back to FIG. 1, a method of notifying the UE (referred to in general as “UE 13”) regarding subscription status (responsive to a an account activation request) can include steps of determining, from subscription information associated with UE 13, the current subscription status of UE 13. For example, the subscription information may be stored in an SPR on a server, such as HSS 37. PCRF 47 determines the subscription status of the UE 13 from the subscription information on HSS 37, and instructs PGW 45 to indicate the subscription status to the UE 13. PGW 45, responsive to PCRF 47, sends a subscriptions status notification message through network 15 to UE 13.

A method of notifying UE 13 regarding data usage can include the steps of tracking an amount of data usage being used by the mobile device. This tracking may occur at the PGW 45 communicating with UE 13 through mobile network 15. It can then be determined, from the user account for UE 13 a data usage limit. The user account information typically is stored on the server, such as OCS 35. OCS 35 can then determine whether a criterion is met by comparing the amount of data usage to the data usage limit. In some examples, the data usage limit may also include “time of day” restrictions. From this comparison, a data usage amount is determined. Consequently, it can be determined whether the data usage amount exceeds the data usage limit. Upon determining that the data usage amount meets a criterion, then the system, via PGW 45 sends a data usage notification message to UE 13.

UE 13 may include one or more clients (e.g., application programs) that run on the UE and that are configured to receive input and/or instructions from PGW 45 through network 15. In one example, a client triggers a pop-up message on UE 13 indicating Internet service is restricted, offering different subscription options and/or replenishment options. For example, the user may be notified that their account has run out of money, has reached a data limit, or is under a data restriction. An option may be provided to allow the user of UE 13 to suspend their service, until the next billing cycle rolls around so the account does not enter into overages.

Further, a client within UE 13 controls access of the UE communication capability with the network 10. For example, the client can trigger activation/deactivation of communication capability with IMS 15, Internet 23 and sponsored service PDN 39. The activation/deactivation may be performed by the same client that triggers the pop-up message or a separate client. The client receives activation/deactivation instructions from the notification message.

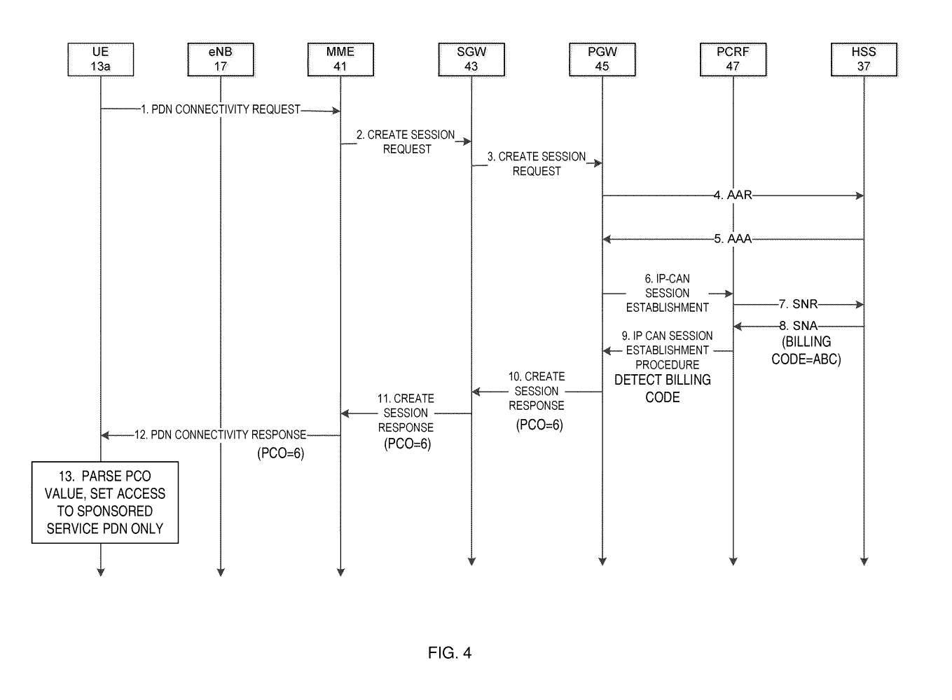

With the foregoing overview of the system, it may be helpful now to consider a high-level discussion of an example of a subscription status notification message of UE 13a having a sponsored (enterprise) service plan only (.i.e., no service provider subscription plan), during account activation. FIG. 4 illustrates an example signal flow diagram of a 3GPP LTE session when UE 13a attaches to network 10 (or connects to sponsored service PDN 39). In FIG. 4, the signal flow includes an interaction between UE 13a, eNB 17, MME 41, SGW 43, PGW 45, PCRF 47 and HSS 37.

The process begins at step 1, when UE 13a is powered up and initiates an IMS PDN (network 15) connection. At step 1, UE 13a sends a PDN connectivity request to MME 41, via eNB 17. At step 2, MME 41 sends a create session request to SGW 43, responsive to the PDN connectivity request (step 1), to create a data session. At step 3, SGW 43 forwards the create session request (received from MME 41) to PGW 45, to create the data session.

At step 4, PGW 45 sends an Authentication Authorization Request (AAR) to AAA/HSS 37 to authorize network services for the subscriber. For example, AAA/HSS 37 provides authentication of the UE 13a and/or user and determines if the UE 13a and/or user is authorized to use a network service. Further, AAA/HSS 37 accumulates accounting records that could be used for billing purposes.

At step 5, AAA/HSS 37 retrieves the profile of UE 13a and sends the retrieved subscriber profile for the particular UE 13a to PGW 45.

At step 6, PGW 45 sends a credit control request (CCR) to PCRF 47 to request policy information in connection with UE 13a (to establish an IP connectivity access network (CAN) session). At step 7, responsive to the CCR, PCRF 47 sends a status notification request (SNR) to HSS 37 to download the SPR profile for UE 13a. At step 8, HSS 37 sends the SPR profile to PCRF 47 in a status notification answer (SNA).

When the subscriber only has a sponsored data service plan but no service provider service plan (such as UE 13a), a special (sponsor data) billing plan code (e.g., ABC) is added to the accounting records for that subscriber. HSS 37 sends the special billing plan code (as part of the subscriber profile in step 8) to PCRF 47, when HSS 37 detects that the special billing plan code is on the subscriber's account.

At step 9, PCRF 47 sends back the policy information to PGW 45. PCRF 47 also detects the sponsor data billing plan code (e.g., ABC indicating a sponsored data service plan only) in the received SPR profile. PCRF 47 instructs PGW 45 to install rules on PGW 45 to permit IP Portal traffic but block and/or restrict other data traffic (except for traffic to sponsored service PDN 39). For example, rules as shown in the first column of the table of FIG. 3 may be installed. In some examples, the rules include permitting connection only through a particular set of access points based on the sponsored data service, e.g., access points within an identified range of facilities of a retail enterprise.

At step 10, PGW 45 installs the rules indicated by PCRF 47 (in step 9) and sends a create session response to SGW 43. The create session response includes an IP address and a subscription status notification message. The notification message is indicated by setting the PCO action code value to 6 (indicating a sponsored data service plan only) in the create session response message. At step 11, SGW 43 forwards the create session response to MME 41 with the PCO information (indicating the subscription status of UE 13a).

At step 12, MME 41 sends a PDN connectivity response to UE 13a via eNB 17. For example, MME 41 sends an evolved packet system radio access bearer (E RAB) request to eNB 17 which includes the PCO information. The eNB 17 sends a radio resource control (RRC) connection request to UE 13a which includes the PCO information.

At step 13, UE 13a parses the PCO information to retrieve the subscription status and follows the instructions accordingly. For example, when UE 13a receives the action code value of 6 in the PCO, UE 13a turns off (or restricts) access to Internet 23 (see first column of the table in FIG. 3).

Sponsored (enterprise) data traffic on sponsored service PDN 39 is allowed by network 15 so that the subscriber can use the sponsored data service applications. The network 15 installs special policies and rules to allow traffic to network 15 to pass through so that the subscriber of UE 13a can purchase a service provider data service plan, but blocks the rest of other data traffic on Internet 23.

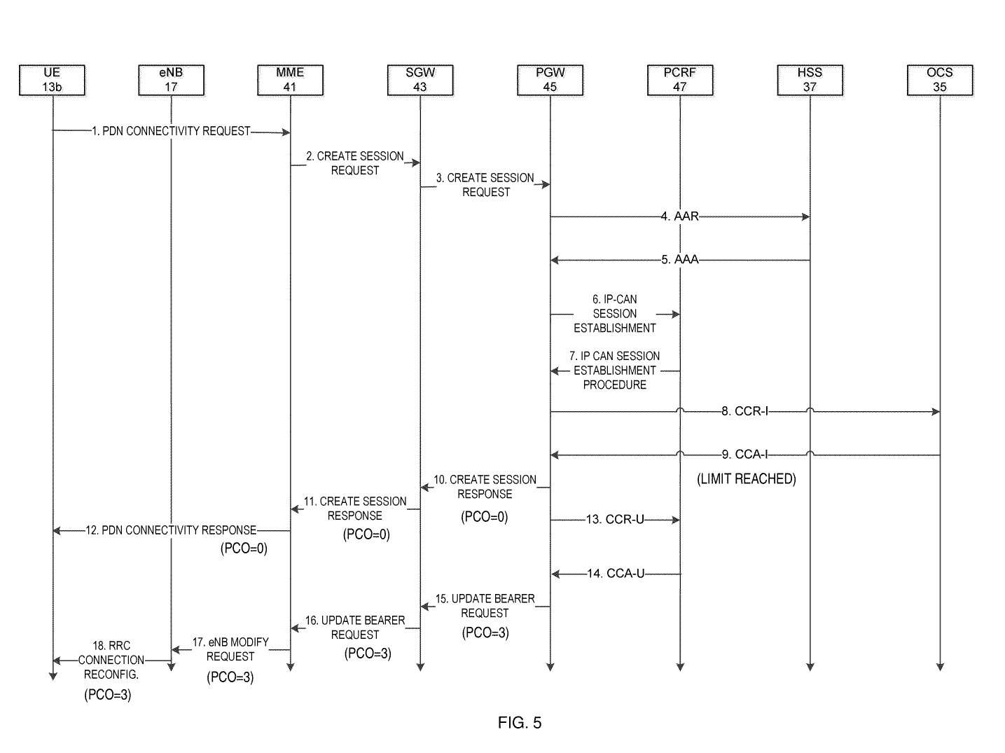

Thus, when a device (such as UE 13a or UE 13b) attaches to the network 15, the network 15 responds with a subscription status notification message (indicated in a PCO action code) to the UE. Although FIG. 4 illustrates an account registration procedure for UE 13a (subscribing to a sponsored data service plan only), a similar account activation procedure occurs for UE 13b (subscribing to a sponsored data service plan and a service provider data service plan). In particular, steps 1-7 are similar for UE 13b as described above with respect to UE 13a. In steps 8 and 9, however, the special billing code is not detected. Thus, in step 9, the PCO action code value is set to 0 (as shown in the second column of the table in FIG. 3). Steps 10-12 are similar, except that the PCO action code of 0 (for unrestricted use) is sent to UE 13b. The description assumes that UE 13b has a positive balance and/or is within a data usage limitation. A change in data usage of UE 13b is described below with respect to FIG. 5.

For customers with a sponsored data service plan and a service provider data service plan (such as UE 13b), the network 10 can monitor the data usage. When a data usage limit is reached, network 10 sends a data usage notification message (e.g., a PCO action code value) to UE 13b indicating that the data usage limit is reached. At the network side, network 10 installs a set of special policies and rules to allow traffic to Internet 23 to pass through so that the subscriber can still purchase/change/replenish the service provider data service plan, but blocks other data traffic on Internet 23. For example, rules as shown in the third column of the table of FIG. 3 may be installed. However, sponsored service data traffic, on sponsored service PDN 39 is allowed by network 10 so that subscriber can continue to use sponsored applications of the sponsored data service.

FIG. 5 illustrates an example signal flow diagram of a 3GPP LTE session when UE 13b continues to communicate with the network 10 after having exceeded a usage limit. FIG. 5 assumes that account activation for UE 13b has already been performed. In FIG. 5, the signal flow includes an interaction between UE 13b, eNB 17, MME 41, SGW 43, PGW 45, PCRF 47, HSS 37 and OCS 35. As discussed above, UE 13b represents a device having both a sponsored data service plan and a service provider data service plan.

At step 1, UE 13b sends a PDN connectivity request to MME 41 via eNB 17, to initiate an Internet (PDN) 23 connection. At step 2, MME 41 sends a create session request to SGW 43, responsive to the PDN connectivity request (step 1), to create a data session. At step 3, SGW 43 forwards the create session request (received from MME 41) to PGW 45, to create the data session.

At step 4, PGW 45 sends an AAR to AAA/HSS 37 to authorize network services for the subscriber. AAA/HSS 37 also accumulates accounting records that could be used for billing purposes. At step 5, AAA/HSS 37 retrieves the profile of UE 13b and sends the retrieved subscriber profile for UE 13b to PGW 45.

At step 6, PGW 45 sends a CCR to PCRF 47 to request policy information in connection with UE 13b (to establish an IP-CAN session). At step 7, PCRF 47 sends a response credit control answer (CCA) to PGW 45, indicating the policy information. Because the SPR profile is already downloaded to PCRF 47 (during the account activation), PCRF 47 does not need send a message to HSS 37 (to retrieve the SPR profile again).

At step 8, PGW 45 determines (from the received policy information in step 7), that the user of UE 13b subscribes to a service provider data subscription plan (e.g., a prepaid plan in which a subscriber has fixed availability of usage of a voice/data resource or a postpaid plan in which a fixed fee is applied for using a certain amount of a resource within a certain time cycle). Responsive to the determination, PGW 45 sends a CCR to OCS 35, to request an account status (i.e., whether a minimum balance and/or a data usage limit has been reached). OCS 35 has account information, including account criteria such as a minimum balance and/or a data usage limit. At step 9, OCS 35 determines that a minimum balance and/or data usage limit has been reached and sends a CCA indicating that the limit is reached.

At step 10, PGW 45 sends a create session response to SGW 43. The create session response includes an IP address and a subscription status notification message. The notification message is indicated by setting the PCO action code value to 0 (indicating normal data flow) in the create session response message. At step 11, SGW 43 forwards the create session response to MME 41 with the PCO information (indicating the subscription status of UE 13b). At step 12, a PDN connectivity response (including PCO action value=0) is sent from MME 41 to UE 13b via eNB 17, and Internet PDN 23 is setup.

A step 13, PGW 45 sends a CCR to PCRF 47, to indicate to PCRF 47 that the subscriber has reached the predetermined credit/data usage limitation. At step 14, PCRF 47 sends a CCA to PGW instructing PGW 45 to install rules to permit IP Portal traffic but to block and/or restrict other data traffic (except for traffic to sponsored service PDN 39). For example, rules as shown in the third column of the table of FIG. 3 may be installed.

At step 15, PGW 45 installs the rules indicated by PCRF 47 (in step 14), generates an update bearer request and sets the PCO action code to 3. The PCO action code of 3 indicates limited network access except to redirect the user to a service provider site to change/replenish the subscriber's service provider data service plan. PGW 45, at step 15, also sends the update bearer request to SGW 43. At step 16, SGW 43 forwards the update bearer request to MME 41.

At step 17, MME 41 sends an eNB modify request to eNB 17. At step 18, eNB 17 sends an RRC connection reconfiguration request to UE 13b which includes the updated PCO information. UE 13b parses the updated PCO information and behaves accordingly based on the PCO information. For example, when UE 13b receives the action code value of 3 in the PCO, UE 13b restricts access to Internet 23 (see the third column of the table in FIG. 3). Sponsored (enterprise) data traffic on sponsored service PDN 39 is allowed by network 15 so that the subscriber can use the sponsored data service applications. The network 10 installs special policies and rules to allow traffic to network 15 to pass through so that the subscriber of UE 13b can change/replenish the service provider data service plan, but blocks the rest of other data traffic on Internet 23.

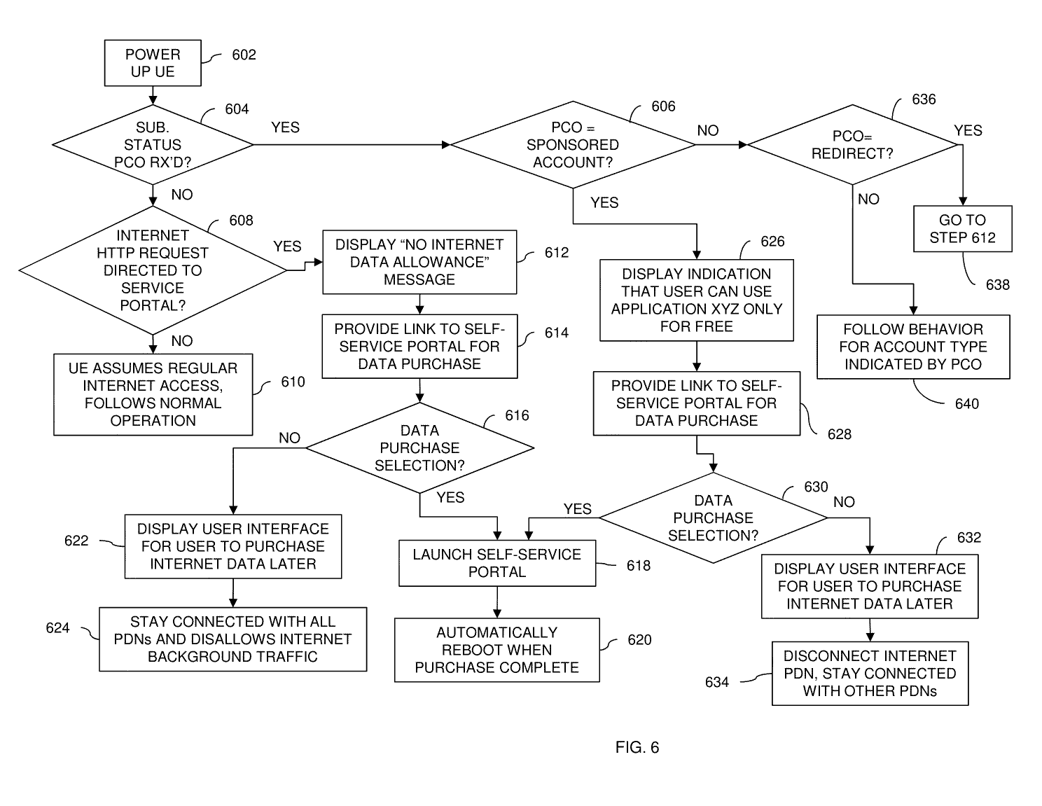

FIG. 6 is a flow chart diagram illustrating an example of network access control by UE 13 (e.g., 13a or 13b) responsive to subscription status notification messaging. Allowing a sponsored data service to transmit data over sponsored service PDN 39 may be performed in various ways, depending on the operating system (OS) of UE 13. For example, in an Android OS, this can be performed by an IP address routing table in OEM software code; or in Windows OS, this can be performed via an operator preloaded application list that has privilege to run on sponsored service PDN 39. UE 13 can request the subscription status in a PCO message from network 10 when UE 13 attempts to register to wireless cellular network 10. When network 10 returns the PCO value (such as in step 12 of FIG. 4), a modem of UE 13 broadcasts the PCO value to the application software layer of UE 13. The application layer is capable of interpreting the PCO value and taking action(s) accordingly.

At step 602, UE 13 is powered up. At step 604, it is determined whether UE 13 has received a subscription status PCO value. If it is determined, at step 604, that UE 13 has received a subscription status PO value, step 604 proceeds to step 606.

If it is determined, at step 604, that a subscription status value is not received, step 604 proceeds to step 608. At step 608, it is determined whether an Internet hypertext transfer protocol (HTTP) request is being redirected to a service provider data service portal.

If it is determined, at step 608, that the Internet HTTP request is not directed to a service provider data service portal, step 608 proceeds to step 610 and UE 13 assumes that it is configured for regular (i.e., normal, unrestricted access) Internet access and it follows normal operation per the service provider's network access specifications.

If it is determined, at step 608, that the Internet HTTP request is directed to a service provider data service portal, step 608 proceeds to step 612. At step 612, UE 13 displays a “No Internet Data Allowance” message. At step 614, UE 13 provides a link to a self-service portal for data purchase with yes/no options for purchasing data. At step 616, it is determined whether a data purchase selection is received from the user of UE 13, responsive to step 614.

If it is determined, at step 616, that a data purchase is selected, step 616 proceeds to step 618. At step 618, UE 13 launches a service provider self-service portal to purchase a service provider data service plan. At step 620, UE 13 automatically reboots when the service plan purchase is complete.

If it is determined, at step 616, that a data purchase is not selected, step 616 proceeds to step 622. At step 622, UE 13 displays a user interface for the user to purchase a service provider data service plan (i.e., for Internet data service) at another (later) time. At step 624, UE 13 allows the device modem to stay connected with all PDNs and disallows Internet background traffic.

If it is determined, at step 604, that a subscription status value is received, step 604 proceeds to step 606. At step 606, it is determined whether the PCO subscription value indicates a sponsored data service account only (i.e., PCO=6). If the PCO subscription value indicates a sponsored data service account only, step 606 proceeds to step 626.

At step 626, UE 13 displays an indication that the user can only use Application XYZ (associated with the sponsored data service) for free. At step 628, UE 13 provides a link to a self-service portal for data purchase with yes/no options for purchasing data. At step 630, it is determined whether a data purchase selection is received from the user of UE 13, responsive to step 628.

If it is determined, at step 630, that a data purchase is selected, step 630 proceeds to step 618, and step 618 and 620 are repeated.

If it is determined, at step 630, that a data purchase is not selected, step 630 proceeds to step 632. At step 632, UE 13 displays a user interface for the user to purchase a service provider data service plan (i.e., for Internet data service) at another time. At step 634, UE 13 disconnects from Internet PDN 23, and stays connected to other PDNs including sponsored service PDN 39, so that the sponsored data transmission can still pass through network 10.

In some examples, it may be desirable to disable Internet PDN 23, to restrict preloaded background applications of the UE's operating system from continually pinging network 10 to request access, when the account type does not support Internet 23 access. Reducing network pinging can reduce overhead in terms of network and communication resources, as well as reducing the UE's CPU usage, memory usage and increasing the UE's battery life. In some examples, the UE 13 displays an indication to the user that the application (e.g., Internet data service) and various background communication resources are suspended until the service provider data service plan is purchased or recharged.

In some examples, UE 13 may not be subscription status PCO value capable, or may not receive a PCO value from network 10 (steps 608-624). The sponsored data is still transmitted over sponsored service PDN 39. In some examples, UE 13 may not display an instructional message to user regarding network access. If the user attempts to run a non-sponsored data application, the user receives an error message, a time out message or a message providing additional information and indicating a proper course of action. If the user attempts to browse Internet 23, the browser URL is redirected to the service provider's service portal.

If it is determined, at step 606, that the PCO subscription value does not indicate a sponsored data service account only (i.e., PCO is not equal to 6), step 606 proceeds to step 636.

At step 636, it is determined whether the PCO value indicates a redirect (e.g., PCO=3). If the PCO value indicates redirect, step 636 proceeds to step 638, and steps 612-624 are repeated. If the PCO value does not indicate redirect, step 636 proceeds to step 640. At step 640, UE 13 follows the defined behavior for the specific account type indicated by the PCO value.

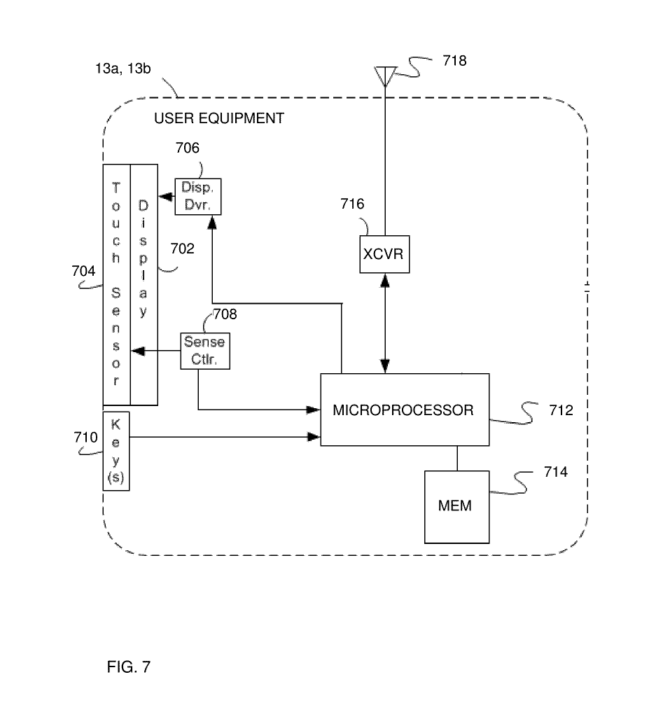

FIG. 7 is a block diagram of an example UE 13 (e.g., 13a or 13b). In some examples, UE 13a, 13b may be implemented as a tablet computer (as illustrated by UE 13a in FIG. 1) or as a mobile device (as illustrate by UE 13b in FIG. 1). In general, UE 13a, 13b may be implemented as any portable computing device capable of using sponsored enterprise data applications.

The example the UE 13 shown in FIG. 7 includes display 702 and touch sensor 704 controlled by display driver 706 and sense control circuit 708 respectively. UE 13 may also include keys 710 that provide additional input. Of course other user interface hardware components may be used in place of or instead of the display, touch sensor and keys, depending on the expected types of sponsored data applications.

The UE 13 includes one or more processor circuits implementing a CPU functionality for data processing and operational control of UE 13, including for operations involved in network access based on the notification messaging service under consideration here (such as the functions shown in FIG. 6). Although a microcontroller or other type of processor circuit may be used, in the example, the CPU processor of UE 13 takes the form of a microprocessor 712.

Programs and data for microprocessor 712 are stored in memory 714. Memory 714 may include flash type program memory for storage of various “software” or “firmware” program routines and configuration settings, such as mobile directory number (MDN), an IMSI and/or a mobile identification number (MIN), etc. The UE 13 may also include a non-volatile random access memory for a working data processing memory. Of course, other storage devices or configurations may be added to or substituted for those in the example. In some examples, memory 714 may include both random access memory and flash memory.

The UE 13 includes transceiver (XCVR) 716 coupled to antenna 718, for digital wireless communications. The concepts discussed here encompass embodiments of UE 13 utilizing any digital transceivers that conform to current or future developed digital wireless communication standards. The UE 13 may also be capable of analog operation via a legacy network technology. Transceiver 716 provides two-way wireless communication of information, in accordance with the technology of the network 10. Transceiver 716 also sends and receives a variety of signaling messages in support of the various data services provided via UE 13 and the communication network. Transceiver 716 also receives subscription status and/or data usage notification messages from network 15.

Keys 710, display driver 706, sense control circuit 708, transceiver 716 and memory 714 are all coupled to microprocessor 712. Operation of UE 13 is controlled by microprocessor execution of programming from memory 714.

As shown by the above discussion, functions relating to the subscription status messaging service may be implemented on computers connected for data communication via the components of a packet data network, operating as the various servers and/or user terminals, as shown in FIG. 1. Although special purpose devices may be used for the servers, such devices also may be implemented using one or more hardware platforms intended to represent a general class of data processing device commonly used to run “server” programming so as to implement the subscription status messaging functions discussed above, albeit with an appropriate network connection for data communication. User terminal devices such as 13a, 13b similarly may be implemented on general purpose computers, albeit with appropriate user interface elements and programming.

As known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data, e.g., files used for the subscription status messaging service. For each of the various server platforms, the software code is executable by the general-purpose computer that functions as a server and/or that functions as a terminal device. In operation, the code is stored within the general-purpose computer platform. At other times, however, the software may be stored at other locations and/or transported for loading into the appropriate general-purpose computer system. Execution of such code by a processor of the computer platform enables the platform to implement the methodology for the subscription status messaging service, in essentially the manner performed in the implementations discussed and illustrated herein.

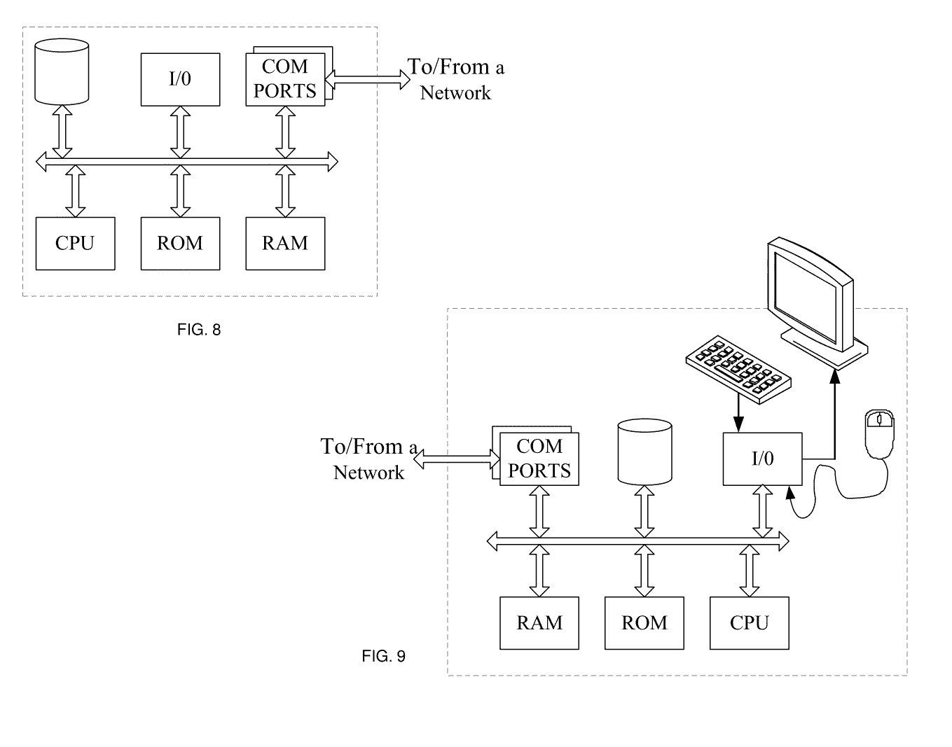

FIGS. 8 and 9 provide functional block diagram illustrations of general purpose computer hardware platforms. FIG. 8 illustrates a network or host computer platform, as may typically be used to implement a server, including any of the servers shown in FIG. 1. FIG. 9 depicts a computer with user interface elements, as may be used to implement a personal computer or other type of work station or terminal device, although the computer of FIG. 9 may also act as a server if appropriately programmed. It is believed that the general structure and general operation of such equipment as shown in FIGS. 8 and 9 should be self-explanatory from the high-level illustrations.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature. Of course, the server functions may be implemented in a distributed fashion on a number of similar platforms, to distribute the processing load.

A computer type user terminal device, such as a PC or tablet computer, similarly includes a data communication interface CPU, main memory and one or more mass storage devices for storing user data and the various executable programs (see FIG. 9). A mobile device type user terminal may include similar elements, but will typically use smaller components that also require less power, to facilitate implementation in a portable form factor. The various types of user terminal devices will also include various user input and output elements. A computer, for example, may include a keyboard and a cursor control/selection device such as a mouse, trackball, joystick or touchpad; and a display for visual outputs. A microphone and speaker enable audio input and output. Some smartphones include similar but smaller input and output elements. Tablets and other types of smartphones utilize touch sensitive display screens, instead of separate keyboard and cursor control elements. The hardware elements, operating systems and programming languages of such user terminal devices also are conventional in nature.

Hence, aspects of the subscription status messaging service outlined above may be embodied in programming. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms. Non-volatile storage media include, for example, optical or magnetic disks, such as any of the storage devices in any computer(s) or the like, such as may be used to implement the aspects shown in the drawings. Volatile storage media include dynamic memory, such as main memory of such a computer platform. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge. Many of these forms of non-transitory computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

### APPENDIX: ACRONYM LIST

The description above has a large number of acronyms to refer to various devices, messages and system components. Although generally known, use of several of these acronyms is not strictly standardized in the art. For the convenience of the reader, the following list correlates terms to acronyms, as used by way of example in the detailed description above.

AAA—Authentication and Access Authorization

AAR—Authentication Authorization Request

BS—Base Station

CCA—Credit Control Answer

CCR—Credit Control Request

CD-ROM—Compact Disk Read Only Memory

CPU—Central Processing Unit

DVD—Digital Video Disk

DVD-ROM—Digital Video Disk Read Only Memory

E RAB—Evolved Packet System Radio Access Bearer

EEPROM—Electrically Erasable Programmable Read Only Memory

eNB, eNodeB—evolved node B

EPC—Evolved Packet Core

EPROM—Erasable Programmable Read Only Memory

EPS—Evolved Packet System

FLASH-EPROM—Flash Erasable Programmable Read Only Memory

HSS—Home Subscriber Server

HTTP—Hypertext Transfer Protocol

IMS—Internet Protocol Multimedia Subsystem

IMSI—International Mobile Subscriber Identity

IP—Internet Protocol

IP-CAN—Internet Protocol Connectivity Access Network

LTE—Long Term Evolution

MME—Mobility Management Entity

MMS—Multimedia Messaging Service

MSISDN—Mobile Station International Subscriber Directory Number

OCS—Online Charging System

OS—Operating System

PCEF—Policy Control Enforcement Function

PCO—Protocol Configuration Option

QoS—Quality of Service

PCRF—Policy Control and Charging Rules Function

PDN—Packet Data Network

PGW—Packet Data Network Gateway

PROM—Programmable Read Only Memory

PC—Personal Computer

PDA—Personal Digital Assistant

PSTN—Public Switched Telephone Network

RAM—Random Access Memory

RCS—Rich Communication Suite

RF—Radio Frequency

RIM—Research In Motion

ROM—Read Only Memory

RRC—Radio Resource Control

SAE—System Architecture Evolution

SGW—Serving Gateway

SIM—Subscriber Identifier Module

SMS—Short Message Service

SNR—Status Notification Request

SPR—Subscription Profile Repository

UE—User Equipment

URL—Uniform Resource Locator

What is claimed is:

1. A method comprising:
receiving, by at least one server through a wireless packet data communication network, a request from a user equipment (UE) to attach to the wireless packet data communication network;
determining, by the at least one server, whether the UE is associated with an enterprise identified by a service provider of the wireless packet data communication network as a sponsor of a data service through the network, based on an account of the UE stored on the at least one server;
upon determining that the UE is associated with the enterprise, sending a notification message from the at least one server to the UE through an information element field within an existing message in a bearer channel of the wireless packet data communication network, the notification message indicating a subscription status of the UE; and
responsive to the subscription status in the notification message, configuring the UE to control access to the wireless packet data communication network, to permit access to the data service associated with the enterprise regardless of an ability of the UE to access data services not associated with the enterprise.

2. The method of claim 1, wherein the information element field is a protocol configuration option (PCO), the notification message being sent in at least one of field of the PCO.

3. The method of claim 1, wherein the account of the UE is not billed for usage of the data service associated with the enterprise.

4. The method of claim 1, wherein:
the determining of whether the UE is associated with the enterprise includes determining that the UE is not associated with a service provider account of another data service,
the subscription status indicates that the UE is not associated with the other data service, and
the UE, responsive to the subscription status in the notification message, restricts access to the other data service.

5. The method of claim 4, wherein the notification message to the UE comprises instructions to provide an indication on a user interface of the UE that the UE is restricted from access to the other data service.

6. The method of claim 4, wherein the notification message to the UE comprises instructions to provide at least one option on a user interface of the UE to purchase the service provider account, to access the other data service of the service provider account.

7. The method of claim 6, wherein the instructions instruct the UE to redirect the UE to a web site of the service provider where the at least one option is provided.

8. The method of claim 6, further comprising:
receiving, by the at least one server, an indication of purchase of the service provider account by the user of the UE;
sending a further notification message from the at least one server to the UE in the bearer channel of the wireless packet data communication network, responsive to the purchase indication, the further notification message indicating an updated subscription status of the UE; and
responsive to the updated subscription status in the further notification message, configuring the UE to permit access, over the wireless packet data communication network, to the other data service of the service provider account.

9. The method of claim 1, wherein the UE is associated with another data service of a service provider account, the method further comprising:
comparing, on the at least one server, a data usage of the other data service of the service provider account to a data usage criterion;
upon determining, based on the comparing, that the data usage has met the data usage criterion, sending a data usage notification message from the at least one server to the UE in the bearer channel of the wireless packet data communication network; and
responsive to the data usage notification message, configuring the UE to restrict access to the other data service of the service provider account.

10. The method of claim 9, wherein the data usage notification message to the UE comprises instructions to provide at least one option on a user interface of the UE to at least one of replenish the account or update the account.

11. User equipment, comprising:
a wireless mobile transceiver;
at least one user interface element configured to receive a user input and to provide information output to the user;
a processor;
a memory accessible to the processor; and
programming in the memory, wherein execution of the programming by the processor configures the user equipment to perform functions, including functions to:
send, via the wireless mobile transceiver to at least one server through a wireless packet data communication network, a request to attach to the wireless packet data communication network, the user equipment associated with an enterprise identified by a service provider of the wireless packet data communication network as a sponsor of a data service through the network,
receive, via the wireless transceiver, a notification message from the at least one server to the user equipment through an information element field within an existing message in a bearer channel of the wireless packet data communication network, the notification message indicating a subscription status of the user equipment,
identify, by the processor, the subscription status in the received notification message, and
responsive to the identified subscription status, configure the user equipment to control access to the wireless packet data communication network, to permit access to the data service associated with the enterprise regardless of an ability of the user equipment to access data services not associated with the enterprise, the user equipment configured to restrict access to another data service not associated with the sponsored data service when the user equipment is not associated with a service provider account of the other data service.

12. The user equipment of claim 11, wherein the information element field is a protocol configuration option (PCO), the notification message being sent in at least one of field of the PCO.

13. The user equipment of claim 11, wherein the notification message to the user equipment comprises instructions, the user equipment being configured, responsive to the instructions, to provide an indication on the at least one user interface element that the user equipment is restricted from access to the other data service, when the user equipment is not associated with the service provider account of the other data service.

14. The user equipment of claim 11, wherein the notification message to the user equipment comprises instructions, the user equipment being configured, responsive to the instructions, to provide at least one option on the at least one user interface element to purchase the service provider account, when the user equipment is not associated with the service provider account of the other data service.

15. The user equipment of claim 14, wherein the instructions instruct the user equipment to redirect the user equipment to a web site of the service provider where the at least one option is provided.

16. The user equipment of claim 14, wherein the functions further include functions to:
receive, via the wireless transceiver, a further notification message from the at least one server in the bearer channel of the wireless packet data communication network, responsive to purchase of the service provider account by the user of the user equipment, the further notification message indicating an updated subscription status of the user equipment,
identify, by the processor, the updated subscription status in the received further notification message, and
responsive to the identified updated subscription status, configure the user equipment to permit access, over the wireless packet data communication network, to the other data service associated with the service provider account.

17. A non-transitory computer readable medium that stores instructions in at least one storage device executable by one or more servers in a wireless packet data communication network to cause the one or more servers to perform functions, including functions to:
receive, by the one or more servers through the wireless packet data communication network, a request from a user equipment (UE) to attach to the wireless packet data communication network;
determine, by the one or more servers, whether the UE is associated with an enterprise identified by a service provider of the wireless packet data communication network as a sponsor of a data service through the network, based on an account of the UE stored on the one or more servers; and
upon determining that the UE is associated with the enterprise, send a notification message from the one or more servers to the UE through an information element field within an existing message in a bearer channel of the wireless packet data communication network, the notification message indicating a subscription status of the UE,
wherein the UE controls access to the wireless packet data communication network responsive to the subscription status in the notification message, such that access to the data service associated with the enterprise is permitted regardless of an ability of the UE to access data services not associated with the enterprise, access to another data service not associated with the sponsored data service being restricted when the UE is not associated with a service provider account of the other data service.

18. The non-transitory computer readable medium of claim 17, wherein the notification message to the UE comprises instructions, the instructions including at least one of providing an indication on a user interface of the UE that the UE is restricted from access to the other data service or providing at least one option on the user interface to purchase the service provider account including the other data service, when the UE is not associated with the service provider account of the other data service.

19. The non-transitory computer readable medium of claim 17, wherein, when the UE is not associated with the service provider account of the other data service, the functions further include functions to:
identify, by the one or more servers, a change in the subscription status of the UE, the change in the subscription status indicating purchase, by the user of the UE, of the service provider account including the other data service; and
send a further notification message from the one or more servers to the UE in the bearer channel of the wireless packet data communication network, responsive to the change in the subscription status, the further notification message indicating the changed subscription status of the UE,
wherein the UE permits access to the other data service associated with the service provider account, responsive to the changed subscription status in the further notification message.

20. The non-transitory computer readable medium of claim 17, wherein, when the UE is associated with the service provider account of the other data service, the functions further include functions to:
compare, on the one or more servers, a data usage of the other data service associated with the service provider account to a data usage criterion; and
upon determining, based on the comparing, that the data usage has met the data usage criterion, send a data usage notification message from the one or more servers to the UE in the bearer channel of the wireless packet data communication network,
wherein the UE restricts access to the other data service associated with the service provider account, responsive to the data usage notification message.
